(19) United States
(12) Patent Application Publication
(10) Pub. No.: US 2002/0151353 A1
(43) Pub. Date: Oct. 17, 2002

(54) Gaming device having a bonus game

(76) Inventor: Michael Gauselmann, Espelkamp (DE)

Correspondence Address: Patent Law Group LLP, Suite 223, 2635 North First Street, San Jose, CA, 95134, US

(21) Appl. No.: 10/109,118

(22) Filed: Mar. 27, 2002

(30) Foreign Application Priority Data
Apr. 5, 2001 (DE) 101 17 261.3

(51) Int. Cl. A63F 13/00

(52) U.S. Cl. 463/25

(57) ABSTRACT

The gaming device of the present invention has a main game and a secondary game. Upon winning an award in the main game, the user of the gaming device can decide if he wants to risk any portion of his award and either win or lose that amount in a secondary game. Because the player can decide whether he wants to wager the whole award or just a part of the award, he is actively included in the game and the decision making process, which increases the tension and the fun of the game. In one embodiment, displays are included that display, for the secondary game, the maximum award achievable. Therefore, the player knows how many secondary games must be played (and won) to reach the maximum award. The main game may be a video or actual reel type game (or any other type of game), and the secondary game may be any random selection type of game or a game partly based on a player's decision or skill.

### FIELD OF INVENTION

The invention is related to gaming devices and in particular to a bonus game in conjunction with a main game.

### BACKGROUND

From the German publication DE 2938307.C3, a coin operated gaming machine is known which provides an opportunity for the player to win additional awards. The coin operated gaming machine comprises a gaming device with reels having symbols. If there is a symbol combination on the stopped reels that is associated with an award, this award can be used as a wager in a supplemental game. In the supplemental game, the wager can be lost or almost doubled. The supplemental game comprises a random number generator which is used to determine if an award is granted. The total value of the award from the first game and the supplemental game can be used as a wager in subsequent supplemental games as long as an award is still available to wager or until a maximum award is reached.

U.S. Pat. No. 6,142,873 is but one of many examples of gaming machines that provide a player with an opportunity of an enhanced award based on a special outcome of a main game. If the special outcome from the main game is obtained, a bonus device is activated to randomly, or based partly on a player's skill, generate a bonus award.

In one type of gaming machine, the initial award is multiplied by a randomly generated multiplier. This multiplier may include the value 0. Disadvantages are that there has to be an award won in the main game so that the initial award can be used as a wager for the bonus or secondary game, and the full initial award is wagered.

### SUMMARY

The present gaming device increases the attraction of a player to the gaming device by an additional gaming feature recited in Claim 1. Further characteristics of the invention are included in the other claims.

The gaming device of the present invention has the advantage that the user of the gaming device can decide, after he has achieved an award in the main game, if he wants to risk any portion of his award and either win or lose that amount in a secondary game. Because the player can decide whether he wants to wager the whole award or just a part of the award, he is actively included in the game and the decision making process, which increases the tension and the fun of the game.

In one embodiment, there is a maximum awarded ceiling, and the secondary game may continue as long as there is an award left to wager or the maximum award is obtained.

In one embodiment, displays are included that display, for the secondary game, the maximum award achievable, the present award, the award to be obtained upon a win, and the award to be obtained upon a loss. Therefore, the player always knows what is the maximum award achievable and how many secondary games must be played (and won) to reach the maximum award.

The main game may be a video or actual reel type game (or any other type of game), and the secondary game may be any random selection type of game or a game partly based on a player's decision or skill.

### BRIEF DESCRIPTION OF THE DRAWINGS

FIG. 1 is a perspective view of a gaming machine in accordance with one embodiment of the invention.

FIG. 2 illustrates certain hardware within a gaming machine.

### DETAILED DESCRIPTION

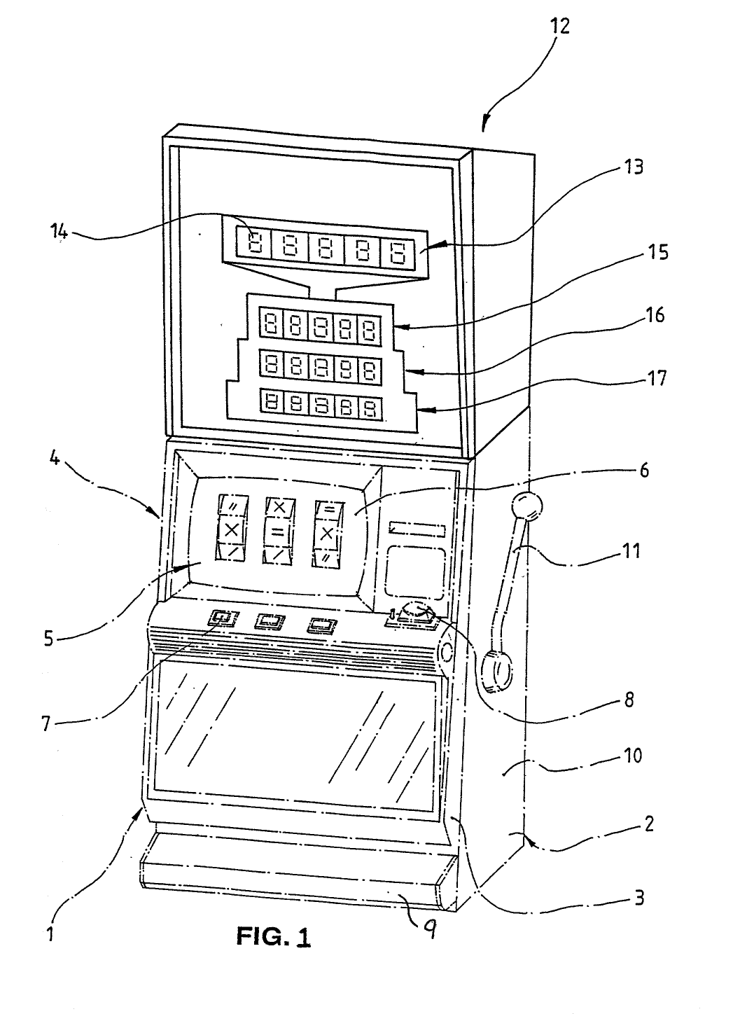

An example of the present invention is shown in FIG. 1.

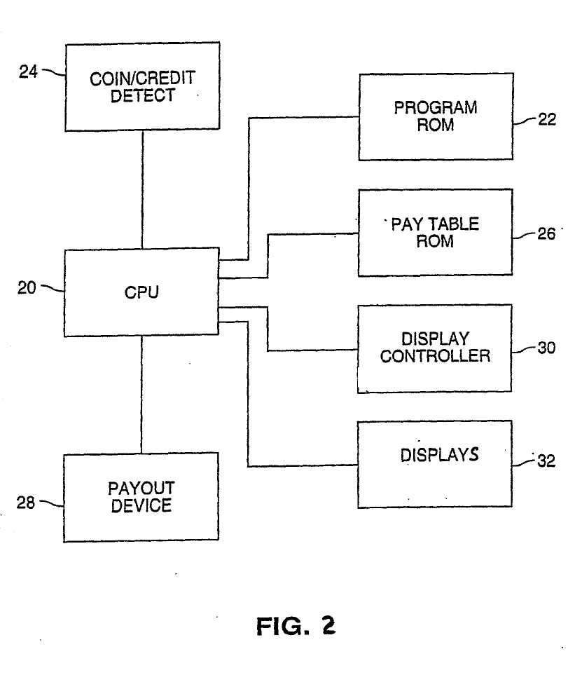

A gaming device 1 comprises a housing 2 with a door on the front 3. In the upper part 4 of the front 3, there is an opening 5 where a display 6 is positioned. Below the display 6, there are control elements 7. A coin input 8 leads inside the housing 2 to a coin verifier (not shown). The control elements 7 (buttons) are connected to a control unit comprising a micro-computer, shown in FIG. 2. At the lower part of the housing 2, there is a coin tray 9. At the side 10 of the housing 2, there is a control element 11 (a handle) connected to the control unit.

The above-elements may comprise conventional hardware in existing types of slot machines.

On the top portion 12 of the housing 2, there are display elements 13, 15, 16, and 17 for use in conjunction with a secondary game. The display elements 13, 15, 16, and 17 each have five digits 14. There may be any number of digits. The display elements 13, 15, 16, and 17 are connected to the control unit of the gaming device.

The following describes the operation of the main game and secondary game. On the display element 13, the maximum award value that can be achieved is shown. On the display element 15, the award that may be won after a successful play of the next secondary game is shown. On the display element 16, the already reached award amount is shown, which may also be the wager for the next secondary game. Alternatively, or in addition, there may be a display of only the wager. On the display element 17, the resulting award if the secondary game ends in a loss situation is shown.

One or more of the control elements 7 of the gaming device 1 can be used to control the main game and secondary game on the gaming device 1. When there are credits on the gaming device 1 and after the control element 11 is activated, a pseudo random number generator of the control unit determines a final symbol combination on the physical or video reels displayed on the display 6. The reels are spun and stopped at the preselected positions, and an award is appropriately granted for winning symbol combinations.

If there is a winning symbol combination on the reels (or a special winning symbol combination), an initial award is won by the player, and the secondary game is activated. The player may use the control elements 7 to wager all or a portion of the award. For example, the control elements 7 may include buttons for betting 0, ¼, ½, or all of the available award, or repeated pressing on a control element 7 may incrementally increase the wager for the secondary game. In one embodiment, the player may only wager all or a portion of the initial award. In other embodiments, the player may wager all or a portion of the entire available award.

The display elements 13, 15, 16, and 17 are activated by the control unit. The award displayed on display element 16 (the player's existing award) can be increased with a subsequent win or decreased with a subsequent loss in the secondary game by the amount of the selected wager. The award that would be achieved with a win is shown on display element 15, and the award that would be achieved if the outcome of the game is a loss is shown on display element 17.

Upon the player activating a control element 7 to initiate the secondary game, the pseudo random number generator of the control unit determines if the next higher award (on display element 15) is granted or is not granted. If the award is granted, the award on the display element 15 is transferred to the display element 16, and the awards shown on display elements 15 and 17 are updated. The secondary game may continue until the maximum award in the display element 13 is reached. At each play of the secondary game, the player may elect the amount of the wager. In one embodiment, the chances are even that a win or loss will occur in each play of the secondary game. The player may end the secondary game at any time by pressing an end game control element 7.

The maximum amount in the display element 13 may be based on the particular winning symbol combination in the main game or may be a fixed amount. For example, a minor winning combination may only give rise to a small maximum amount in the display element 13. The operator/owner of the gaming device 1 can change the maximum award to adjust the average payback of the machine.

The display elements 13, 15, 16, and 17 can be CRTs, TFT displays, LEDs or any other display. The display 6 can be a video screen or reveal motor-driven reels.

FIG. 2 illustrates basic circuit blocks in a suitable gaming device. A control unit (CPU 20) runs a gaming program stored in a program ROM 22. A coin/credit detector 24 enables the CPU 20 to initiate a next game. In one example, the gaming program receives various commands from the gaming device console and pseudo-randomly selects symbols to be displayed on the display 6 or selects the outcome for the secondary game. A pay table ROM 26 detects the various combinations of symbols across activated pay lines in the display 6 and identifies awards to be paid to the player. A payout device 28 pays out an award to the player in the form of coins upon termination of the game or upon the player cashing out. A display controller 30 receives commands from the CPU 20 and generates signals for the various displays 32. If a display 32 is a touch screen, player commands may be input through the display screen into the CPU 20.

All displays shown in FIG. 1 may be on the same video screen. One skilled in the art can write program code to implement the invention without undue experimentation.

Although the gaming device of FIG. 1 has been used as an example, the concepts described herein may be implemented in any type of apparatus used for gaming. Such an apparatus may include computers used for on-line gaming or gaming over any network. Gaming machine 1 may include a card or ticket reader, bill acceptor, and/or a coin slot. A user of gaming machine 1 inputs coins, bills, or a card (such as a smart card, a barcoded ticket, or a credit/debit card) into a reader, in order to activate the game. The awards may be paid out in coins or in any other units. Control inputs 7 may include conventional buttons for placing a bet, initiating the game, and cashing out.

While particular embodiments have been shown and described, it will be obvious to those skilled in the art that changes and modifications may be made without departing from this invention in its broader aspects and, therefore, the appended claims are to encompass within their scope all such changes and modifications as fall within the true spirit and scope of this invention.

What is claimed is:

1. A gaming method comprising:
a. operating a main game to obtain one of a plurality of outcomes, at least one of said outcomes providing an award amount and enabling a secondary game;
b. allowing a player to electronically wager all or a portion of an award amount for playing said secondary game; and
c. activating said secondary game to identify a winning or losing outcome, said winning outcome increasing an award amount by said wager and said losing outcome reducing said award amount by said wager.

2. The method of claim 1 further comprising:
displaying an amount presently won and an amount corresponding to an amount wagered.

3. The method of claim 2 wherein said displaying an amount corresponding to an amount wagered comprises displaying an award to be won after a subsequent win of said secondary game.

4. The method of claim 2 further comprising displaying a maximum amount that can be ultimately won by playing said secondary game.

5. The method of claim 2 wherein said displaying an amount corresponding to an amount wagered comprises displaying an award to be won after a subsequent loss of said secondary game.

6. The method of claim 1 wherein said operating said main game comprises displaying said main game on a first display, and said activating said secondary game comprises displaying said secondary game on at least one additional display.

7. The method of claim 1 wherein said allowing a player to electronically wager all or a portion of said an award amount comprises allowing said player to electronically wager half said award amount.

8. The method of claim 1 further comprising repeating steps b and c.

9. The method of claim 8 wherein said repeating steps b and c comprises repeating steps b and c until a maximum displayed award is reached.

10. The method of claim 1 wherein said operating said main game comprises rotating reels to obtain one of a plurality of symbol combination outcomes.

11. The method of claim 10 wherein said operating said main game comprises electronically displaying rotating reels.

12. The method of claim 10 wherein said operating said main game comprises displaying motor driven rotating reels.

13. The method of claim 1 wherein activating said secondary game comprises randomly selecting a win or loss of said wager to increase or decrease an award amount.

14. The method of claim 1 further comprising displaying a present award amount to said player, displaying a resulting award amount if said secondary game provides a losing outcome, displaying a resulting award amount if said secondary game provides a winning outcome, and displaying a maximum achievable award amount.

15. The method of claim 1 wherein said main game is displayed on a first display, and said secondary game is displayed on at least one different display.

16. The method of claim 1 further comprising displaying a maximum amount that can be ultimately won by playing said secondary game, said maximum amount varying with said award amount from said main game.

17. The method of claim 1 wherein step b comprises allowing a player to electronically wager all or a portion of said award amount from said main game.

18. The method of claim 1 wherein step b comprises allowing a player to electronically wager all or a portion of an award achieved during said secondary game.

19. A gaming device comprising:
at least one processor programmed to carry out the following method:
a. operating a main game to obtain one of a plurality of outcomes, at least one of said outcomes providing an award amount and enabling a secondary game;
b. allowing a player to electronically wager all or a portion of an award amount for playing said secondary game;
c. activating said secondary game to identify a winning or losing outcome, said winning outcome increasing an award amount by said wager and said losing outcome reducing said award amount by said wager.

20. A gaming device comprising:
a first display for displaying operation of a main game to obtain one of a plurality of outcomes, at least one of said outcomes providing an award amount and enabling a secondary game; and
one or more control devices for allowing a player to electronically wager all or a portion of said award amount for playing said secondary game; and
a second display for displaying an award from a secondary game.

21. The device of claim 20 further comprising
a control unit for operating said secondary game to determine a winning or losing outcome, said control unit increasing said award amount by an amount corresponding to said wager in the event of a winning outcome and decreasing said award amount by an amount corresponding to said wager in the event of a losing outcome.

22. The device of claim 21, wherein said control unit comprises a random outcome generator for said secondary game.

23. The device of claim 20 wherein said second display displays an amount presently won and an amount corresponding to an amount wagered.

24. The device of claim 20 wherein said second display displays an award to be won after a subsequent win of said secondary game.

25. The device of claim 20 wherein said second display displays a maximum amount that can be ultimately won by playing said secondary game.

26. The device of claim 20 wherein said second display displays an award to be won after a subsequent loss of said secondary game.

27. The device of claim 20 wherein said one or more control devices for allowing a player to electronically wager all or a portion of said an award amount comprises one or more control devices for allowing said player to electronically wager half said award amount.

28. The device of claim 20 wherein said one or more control devices for allowing a player to electronically wager all or a portion of said an award amount comprises one or more control devices for allowing said player to electronically wager all or a portion of said award amount during repeated plays of said secondary game.

29. The device of claim 28 wherein said repeated plays of said secondary game may continue until a maximum displayed award is reached.

30. The device of claim 20 wherein said main game comprises reels to obtain one of a plurality of symbol combination outcomes.

31. The device of claim 30 wherein said reels are electronically displayed.

32. The device of claim 30 wherein said reels are driven by motors.

33. The device of claim 20 wherein said secondary game comprises a random generator for randomly selecting a win or loss of said wager to increase or decrease an award amount.

34. The device of claim 20 wherein said second display comprises a display for displaying a present award amount to said player, a display for displaying a resulting award amount if said secondary game provides a losing outcome, a display for displaying a resulting award amount if said secondary game provides a winning outcome, and a display for displaying a maximum achievable award amount.

35. The device of claim 20 wherein said first display and said second display use a same display screen.

36. The device of claim 20 wherein said second display displays a maximum amount that can be ultimately won by playing said secondary game, said maximum amount varying with said first award amount.

37. The device of claim 20 wherein said one or more control devices for allowing a player to electronically wager all or a portion of said an award amount comprises one or more control devices for allowing said player to electronically wager all or a portion of said award amount won in said main game.

38. The device of claim 20 wherein said one or more control devices for allowing a player to electronically wager all or a portion of said an award amount comprises one or more control devices for allowing said player to electronically wager all or a portion of an award amount achieved during said secondary game.
